(19) United States
(12) Patent Application Publication
(10) Pub. No.: US 2007/0159415 A1
(43) Pub. Date: Jul. 12, 2007

(54) PLASMA DISPLAY APPARATUS AND METHOD OF DRIVING THE SAME

(75) Inventor: Gyu Young GWAK, Gumi-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/620,882

(22) Filed: Jan. 8, 2007

(30) Foreign Application Priority Data
Jan. 9, 2006 (KR) 10-2006-0002479

(51) Int. Cl. G09G 3/28

(52) U.S. Cl. 345/63

(57) ABSTRACT

A plasma display apparatus and a method of driving the same are disclosed. The plasma display apparatus includes a first driver and a second driver. The first driver supplies the last scan signal to a first electrode, and supplies a first sustain signal and a third sustain signal to the first electrode after a first period. The second driver supplies a second sustain signal to a second electrode between a supply end time point of the first sustain signal and a supply start time point of the third sustain signal. A duration of the first period is more than a duration of a second period ranging from a supply end time point of the second sustain signal to the supply start time point of the third sustain signal.

This Nonprovisional application claims priority under 35 U.S.C. §119(a) on Patent Application No. 10-2006-0002479 filed in Korea on Jan. 9, 2006 the entire contents of which are hereby incorporated by reference.

### BACKGROUND

1. Field

This document relates to a plasma display apparatus and a method of driving the same.

2. Description of the Related Art

A plasma display apparatus includes a plasma display panel including a plurality of electrodes and a driver driving the electrodes of the plasma display panel.

The plasma display panel has the structure in which barrier ribs formed between a front panel and a rear panel forms unit discharge cell or discharge cells. Each discharge cell is filled with an inert gas containing a main discharge gas such as neon (Ne), helium (He) and a mixture of Ne and He, and a small amount of xenon (Xe). The plurality of discharge cells form one pixel. For example, a red (R) discharge cell, a green (G) discharge cell, and a blue (B) discharge cell form one pixel.

When the plasma display panel is discharged by a high frequency voltage, the inert gas generates vacuum ultraviolet rays, which thereby cause phosphors formed between the barrier ribs to emit light, and thus displaying an image.

A driving voltage supplied to the plasma display panel generates a reset discharge during a reset period, an address discharge during an address period, and a sustain discharge during a sustain period, and thus displaying an image.

### SUMMARY

In one aspect, a plasma display apparatus comprises a plasma display panel including a first electrode and a second electrode, a first driver that supplies the last scan signal to the first electrode, and supplies a first sustain signal and a third sustain signal to the first electrode after a first period, and a second driver that supplies a second sustain signal to the second electrode between a supply end time point of the first sustain signal and a supply start time point of the third sustain signal, wherein a duration of the first period is more than a duration of a second period ranging from a supply end time point of the second sustain signal to the supply start time point of the third sustain signal.

The first driver and the second driver may supply the first to third sustain signals in at least one subfield of a plurality of subfields. A duration of the first period may be more than a duration of a second period ranging from a supply end time point of the second sustain signal to a supply start time point of the third sustain signal.

The duration of the first period may range from 1.25 to 3.34 times a width of the third sustain signal.

The first period may range from 3 μs to 8 μs.

A third period may range from the supply end time point of the first sustain signal to a supply start time point of the second sustain signal. A duration of the third period may be more than a duration of the second period.

The duration of the third period may range from 1.25 to 4.17 times a width of the third sustain signal.

The third period may range from 3 μs to 10 μs.

An average picture level (APL) of a first frame may be less than an APL of a second frame. The first driver and the second driver may supply the first to third sustain signals in the first frame. A duration of the first period may be more than a duration of a second period ranging from a supply end time point of the second sustain signal to a supply start time point of the third sustain signal.

The first driver and the second driver may supply the first to third sustain signals in at least one subfield of a plurality of subfields of the first frame. A duration of the first period may be more than a duration of a second period ranging from a supply end time point of the second sustain signal to a supply start time point of the third sustain signal.

A duration of a third period ranging from a supply end time point of the first sustain signal to a supply start time point of the second sustain signal may be more than a duration of a second period ranging from a supply end time point of the second sustain signal to a supply start time point of the third sustain signal. A duration of the first period may be more than the duration of the second period.

A method of driving a plasma display apparatus including a first electrode and a second electrode, the method comprises supplying the last scan signal to the first electrode, and supplying a first sustain signal to the first electrode after a first period, supplying a second sustain signal to the second electrode after a supply end time point of the first sustain signal, and supplying a third sustain signal to the first electrode after a supply end time point of the second sustain signal, wherein a duration of the first period is more than a duration of a second period ranging from the supply end time point of the second sustain signal to a supply start time point of the third sustain signal.

The first to third sustain signals may be supplied in at least one subfield of a plurality of subfields. A duration of the first period may be more than a duration of a second period ranging from a supply end time point of the second sustain signal to a supply start time point of the third sustain signal.

The duration of the first period may range from 1.25 to 3.34 times a width of the third sustain signal.

The first period may range from 3 μs to 8 μs.

A third period may range from the supply end time point of the first sustain signal to a supply start time point of the second sustain signal. A duration of the third period may be more than a duration of the second period.

The duration of the third period may range from 1.25 to 4.17 times a width of the third sustain signal.

The third period may range from 3 μs to 10 μs.

An APL of a first frame may be less than an APL of a second frame, and the first to third sustain signals are supplied in the first frame. A duration of the first period may be more than a duration of a second period ranging from a supply end time point of the second sustain signal to a supply start time point of the third sustain signal.

The first to third sustain signals may be supplied in at least one subfield of a plurality of subfields of the first frame. A duration of the first period may be more than a duration of a second period ranging from a supply end time point of the second sustain signal to a supply start time point of the third sustain signal.

A duration of a third period ranging from a supply end time point of the first sustain signal to a supply start time point of the second sustain signal may be more than a duration of a second period ranging from a supply end time point of the second sustain signal to a supply start time point of the third sustain signal. A duration of the first period may be more than the duration of the second period.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention.

FIG. 1 illustrates a plasma display apparatus according to one embodiment;

FIG. 2 illustrates a plasma display panel of the plasma display apparatus according to one embodiment;

FIG. 3 illustrates a first driving method of the plasma display apparatus according to one embodiment;

FIGS. 4a and 4b illustrate a recombination of charges generated during a first period;

FIG. 5 illustrates a driving second method of the plasma display apparatus according to one embodiment; and

FIG. 6 illustrates a third driving method of the plasma display apparatus according to one embodiment.

### DETAILED DESCRIPTION OF PREFERRED EMBODIMENTS

Reference will now be made in detail embodiments of the invention examples of which are illustrated in the accompanying drawings.

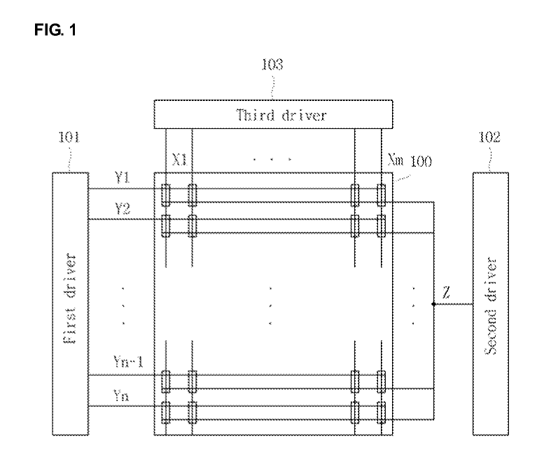

As illustrated in FIG. 1, a plasma display apparatus according to one embodiment includes a plasma display panel 100, a first driver 101, a second driver 102, and a third driver 103.

The plasma display panel 100 includes a first electrode and a second electrode. The first electrode is one of scan electrodes Y1-Yn, and the second electrode is one of sustain electrodes Z. The plasma display panel 100 includes address electrodes X1-Xm supplied with a data signal.

The first driver 101 supplies a reset signal for uniformizing wall charges formed inside a discharge cell of the plasma display panel 100 to the scan electrodes Y1-Yn during a reset period. The first driver 101 supplies a scan signal for selecting a discharge cell to the scan electrodes Y1-Yn during an address period.

The first driver 101 supplies the last scan signal to the first electrode, and supplies a first sustain signal and a third sustain signal to the first electrode after a first period. The second driver 102 supplies a second sustain signal to the second electrode between a supply end time point of the first sustain signal and a supply start time point of the third sustain signal. A duration of the first period may be more than a duration of a second period ranging from a supply end time point of the second sustain signal to the supply start time point of the third sustain signal.

Light is emitted from the discharge cell selected during the address period by operations of the first driver 101 and the second driver 102.

The third driver 103 supplies a data signal synchronized with the scan signal to the address electrodes X1-Xm during the address period.

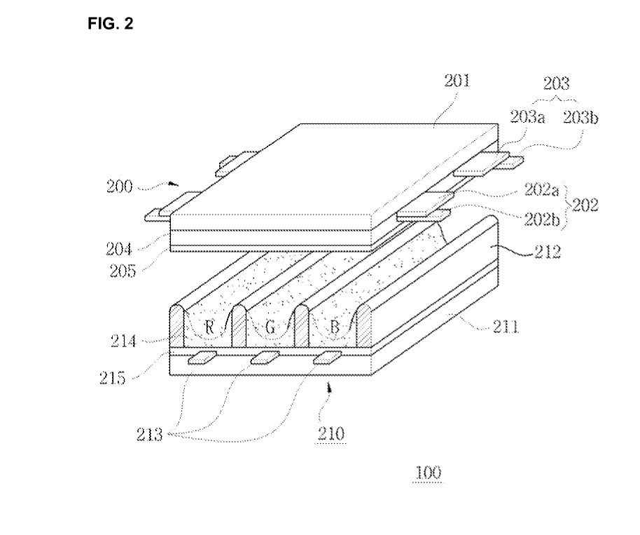

As illustrated in FIG. 2, the plasma display panel 100 of the plasma display apparatus according to one embodiment includes a front panel 200 and a rear panel 210 which are disposed in parallel to each other at a given distance therebetween. A scan electrode 202 and a sustain electrode 203 are positioned on a front substrate 201 of the front panel 200. An address electrode 213 is positioned on a rear substrate 211 of the rear panel 210 to intersect the scan electrode 202 and the sustain electrode 203.

The scan electrode 202 and the sustain electrode 203 each includes transparent electrodes 202a and 203a, and bus electrodes 202b and 203b. An upper dielectric layer 204 covers the scan electrode 202 and the sustain electrode 203 to provide insulation between the scan electrode 202 and the sustain electrode 203. A protective layer 205 covers the upper dielectric layer 204 to protect the scan electrode 202, the sustain electrode 203, and the upper dielectric layer 204, and to emit secondary electrons.

A lower dielectric layer 215 covers the address electrode 213 to provide insulation between the address electrodes 213. Barrier ribs 212 are positioned on the lower dielectric layer 215 to partition a discharge cell. Red (R), green (G) and blue (B) phosphor layers 214 are positioned between the barrier ribs 212 to emit light when generating a sustain discharge.

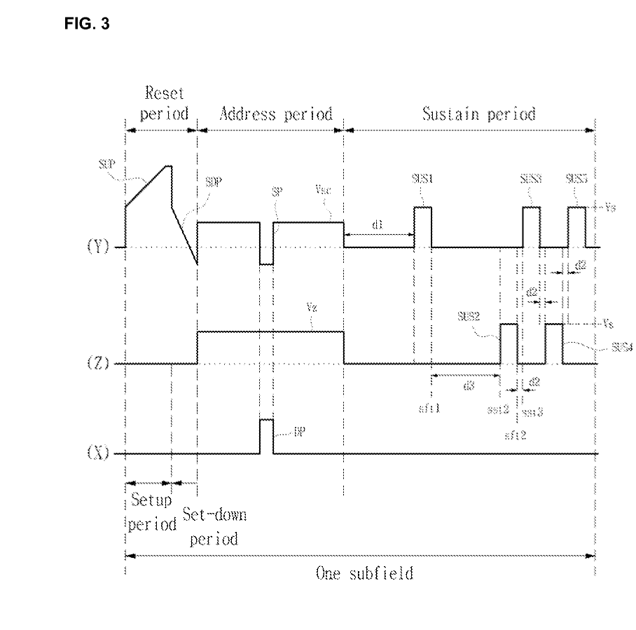

As illustrated in FIG. 3, the first driver 101 supplies a setup signal SUP with a gradually rising voltage and a set-down signal SDP with a gradually falling voltage to the scan electrode Y during a setup period and a set-down period of a reset period. The supplying of the setup signal SUP accumulates a sufficient amount of wall charges inside the discharge cell. The supplying of the set-down signal SDP erases a portion of the wall charges accumulated inside the discharge cell such that the remaining wall charges inside all the discharge cells are uniform.

The first driver 101 supplies a scan signal SP for selecting a discharge cell, where light is to be emitted, to the scan electrode Y during an address period. The first driver 101 supplies a scan reference voltage Vsc for maintaining a state of wall charges remaining inside the discharge cell to the scan electrode Y during the address period. The third driver 103 supplies a data signal DP synchronized with the scan signal SP to the address electrode X. The data signal DP selects the discharge cell where light is to be emitted.

An address discharge occurs inside the discharge cell where the scan signal SP overlaps the data signal DP. During the sustain period, light is emitted from the discharge cell where the address discharge occurs.

The second driver 102 supplies a bias voltage Vz, that smoothly generates the address discharge between the scan electrode Y and the address electrode X, to the sustain electrode Z during the address period

The first driver 101 and the second driver 102 alternately supply first to fifth sustain signals SUS1-SUS5 to the scan electrode Y and the sustain electrode Z during the sustain period. This results in emitting light from the discharge cell where the address discharge occurs.

The first driver 101 supplies the first and third sustain signals SUS1 and SUS3 to the scan electrode Y after a first period d1 from a supply end time point of the last scan signal. The second driver 102 supplies the second sustain signal SUS2 to the sustain electrode Z between a supply end time point sft1 of the first sustain signal SUS1 and a supply start time point sst3 of the third sustain signal SUS3.

A duration of the first period d1 may be more than a duration of a second period d2 ranging from a supply end time point sft2 of the second sustain signal SUS2 to the supply start time point sst3 of the third sustain signal SUS3. The second period d2 may be one of time intervals between the remaining sustain signals except the first and second sustain signals SUS1 and SUS2.

Wall charges formed inside the discharge cell during the period d1 and space charges floating in a space inside the discharge cell are recombined. Accordingly, a portion of the wall charges excessively accumulated by performing the address discharge are recombined with the space charges, and thus is erased.

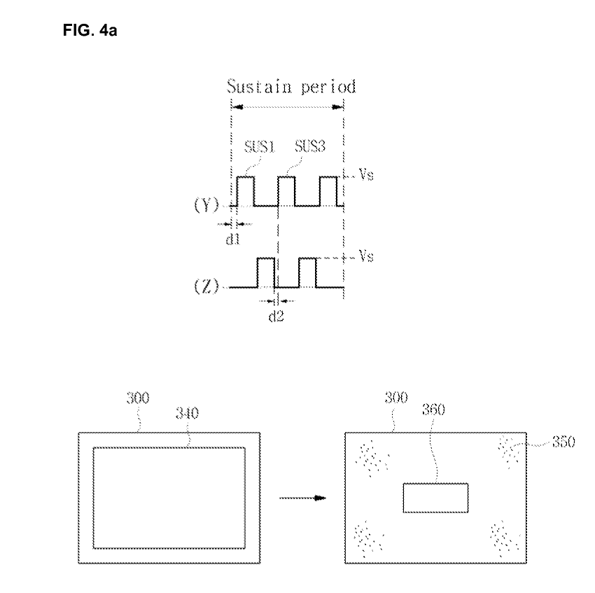

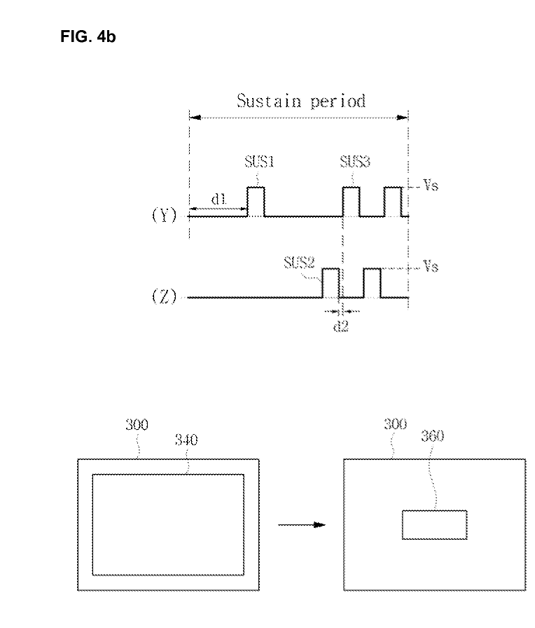

As illustrated at the top of FIG. 4a, in a case where a duration of the first period d1 is less than a duration of the second period d2, a sustain discharge occurs inside a discharge cell, where no address discharge occurs, due to an excessive amount of wall charges accumulated during the address period. As a result, as illustrated at the bottom of FIG. 4a, there is a phenomenon where bright points 350 appear on the screen, thereby worsening an image quality.

As particularly illustrated at the bottom of FIG. 4a, in a case where a first image 340 of a large area is displayed on a plasma display panel 300 and then a second image 360 of a small area is displayed, the number of bright points 350 increases.

As illustrated at the top of FIG. 4b, in a case where a duration of the first period d1 is more than a duration of the second period d2, a portion of wall charges excessively accumulated during the address period is erased such that the generation of bright points decreases. As particularly illustrated at the bottom of FIG. 4b, in a case where the first image 340 of the large area is displayed on the plasma display panel 300 and then the second image 360 of the small area is displayed, an increase in the number of bright points 350 is prevented, or bright points do not appear.

The duration of the first period d1 may range from 1.25 to 3.34 times a width of the third sustain signal SUS3. The first period d1 may range from 3 μs to 8 μs. When the first period d1 ranges from 3 μs to 8 μs, an erroneous discharge is prevented and a sustain discharge occurs stably.

Further, the sustain period may further include a third period d3 to increase an erase amount of wall charges. The third period d3 ranges from the supply end time point sft1 of the first sustain signal SUS1 to the supply start time point sst2 of the second sustain signal SUS2. A duration of the third period d3 may be more than a duration of the second period d2. The duration of the third period d3 may range from 1.25 to 4.17 times the width of the third sustain signal SUS3. The third period d3 may range from 3 μs to 10 μs.

When The third period d3 may range from 3 μs to 10 μs, a proper amount of wall charges is erased such that an erroneous discharge where light is emitted from non-selected discharge cells or light is not emitted from selected discharge cells is prevented.

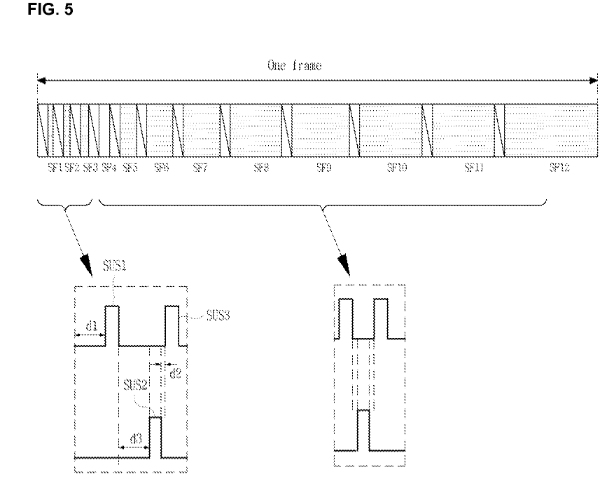

As illustrated in FIG. 5, after the first driver 101 supplies the last scan signal to the scan electrode Y in one or more subfields SF1-SF3 of a plurality of subfields SF1-SF12, the first driver 101 supplies first and third sustain signals SUS1 and SUS3 to the scan electrode Y after a first period d1. The second driver 102 supplies a second sustain signal SUS2 to the sustain electrode Z between a supply end time point sft1 of the first sustain signal SUS1 and a supply start time point sst3 of the third sustain signal SUS3. The duration of the first period d1 may be more than a duration of a second period d2 ranging from a supply end time point sft2 of the second sustain signal SUS2 to the supply start time point sst3 of the third sustain signal SUS3.

Sustain periods of the one or more subfields SF1-SF3 of the plurality of subfields SF1-SF12 may include a third period d3. The third period d3 ranges from the supply end time point sft1 of the first sustain signal SUS1 to a supply start time point sst2 of the second sustain signal SUS2. A duration of the third period d3 may be more than the duration of the second period d2.

Since the sustain periods of the one or more subfields SF1-SF3 of the plurality of subfields SF1-SF12 include the first period d1, or the first period d1 and the third period d3, a reduction in the number of sustain signals is prevented.

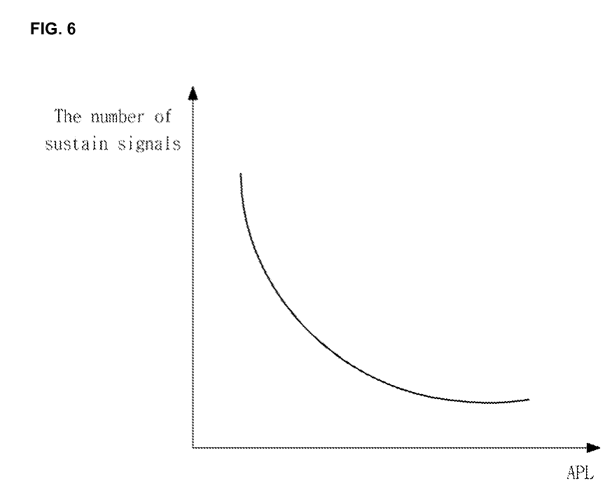

As illustrated in FIG. 6, the number of sustain signals varies with APL (average picture level). In other words, as the APL increases, the number of sustain signals supplied during a frame decreases. For example, as illustrated in FIG. 4b, the number of sustain signals used to display the second image 360 is more than the number of sustain signals used to display the first image 340.

In a case where an APL of a first frame is less than an APL of a second frame, the first driver 101 and the second driver 102 supply first to third sustain signals SUS1-SUS3 in the first frame. Further, in a case where the APL of the first frame is less than the APL of the second frame, the first driver 101 and the second driver 102 may supply first to third sustain signals SUS1-SUS3 of FIG. 3 during at least one subfield of a plurality of subfields. A duration of a first period d1 may be more than a duration of a second period d2 ranging from a supply end time point sft2 of the second sustain signal SUS2 to a supply start time point sst3 of the third sustain signal SUS3.

In a case where the APL of the first frame is less than the APL of the second frame, the first driver 101 and the second driver 102 supply the first to third sustain signals SUS1-SUS3 in the first frame so that sustain periods of the first frame include the first period d1 and the third period d3. Durations of the first period d1 and the third period d3 are more than a duration of the second period d2.

Since the APL is inversely proportional to the number of sustain signals, there is a great likelihood of the generation of bright point due to an erroneous discharge. Accordingly, in the plasma display apparatus according to one embodiment, sustain periods of a frame with a low APL include the first period d1, or the first period d1 and the third period d3. As a result, wall charges and space charges are recombined in the first period d1, or in the first period d1 and the third period d3 such that the likelihood of the generation of the erroneous discharge decreases.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel including a first electrode and a second electrode;
a first driver that supplies the last scan signal to the first electrode, and supplies a first sustain signal and a third sustain signal to the first electrode after a first period; and
a second driver that supplies a second sustain signal to the second electrode between a supply end time point of the first sustain signal and a supply start time point of the third sustain signal,
wherein a duration of the first period is more than a duration of a second period ranging from a supply end time point of the second sustain signal to the supply start time point of the third sustain signal.

2. The plasma display apparatus of claim 1, wherein the first driver and the second driver supply the first to third sustain signals in at least one subfield of a plurality of subfields, and
a duration of the first period is more than a duration of a second period ranging from a supply end time point of the second sustain signal to a supply start time point of the third sustain signal.

3. The plasma display apparatus of claim 1, wherein the duration of the first period ranges from 1.25 to 3.34 times a width of the third sustain signal.

4. The plasma display apparatus of claim 1, wherein the first period ranges from 3 μs to 8 μs.

5. The plasma display apparatus of claim 1, wherein a third period ranges from the supply end time point of the first sustain signal to a supply start time point of the second sustain signal, and
a duration of the third period is more than a duration of the second period.

6. The plasma display apparatus of claim 5, wherein the duration of the third period ranges from 1.25 to 4.17 times a width of the third sustain signal.

7. The plasma display apparatus of claim 5, wherein the third period ranges from 3 μs to 10 μs.

8. The plasma display apparatus of claim 1, wherein an average picture level (APL) of a first frame is less than an APL of a second frame, and the first driver and the second driver supply the first to third sustain signals in the first frame, and
wherein a duration of the first period is more than a duration of a second period ranging from a supply end time point of the second sustain signal to a supply start time point of the third sustain signal.

9. The plasma display apparatus of claim 8, wherein the first driver and the second driver supply the first to third sustain signals in at least one subfield of a plurality of subfields of the first frame, and
a duration of the first period is more than a duration of a second period ranging from a supply end time point of the second sustain signal to a supply start time point of the third sustain signal.

10. The plasma display apparatus of claim 8, a duration of a third period ranging from a supply end time point of the first sustain signal to a supply start time point of the second sustain signal is more than a duration of a second period ranging from a supply end time point of the second sustain signal to a supply start time point of the third sustain signal, and
a duration of the first period is more than the duration of the second period.

11. A method of driving a plasma display apparatus including a first electrode and a second electrode, the method comprising:
supplying the last scan signal to the first electrode, and supplying a first sustain signal to the first electrode after a first period;
supplying a second sustain signal to the second electrode after a supply end time point of the first sustain signal; and
supplying a third sustain signal to the first electrode after a supply end time point of the second sustain signal,
wherein a duration of the first period is more than a duration of a second period ranging from the supply end time point of the second sustain signal to a supply start time point of the third sustain signal.

12. The method of claim 11, wherein the first to third sustain signals are supplied in at least one subfield of a plurality of subfields, and
a duration of the first period is more than a duration of a second period ranging from a supply end time point of the second sustain signal to a supply start time point of the third sustain signal.

13. The method of claim 11, wherein the duration of the first period ranges from 1.25 to 3.34 times a width of the third sustain signal.

14. The method of claim 12, wherein the first period ranges from 3 μs to 8 μs.

15. The method of claim 11, wherein a third period ranges from the supply end time point of the first sustain signal to a supply start time point of the second sustain signal, and
a duration of the third period is more than a duration of the second period.

16. The method of claim 15, wherein the duration of the third period ranges from 1.25 to 4.17 times a width of the third sustain signal.

17. The method of claim 15, wherein the third period ranges from 3 μs to 10 μs.

18. The method of claim 11, wherein an APL of a first frame is less than an APL of a second frame, and the first to third sustain signals are supplied in the first frame, and
a duration of the first period is more than a duration of a second period ranging from a supply end time point of the second sustain signal to a supply start time point of the third sustain signal.

19. The method of claim 18, wherein the first to third sustain signals are supplied in at least one subfield of a plurality of subfields of the first frame, and
a duration of the first period is more than a duration of a second period ranging from a supply end time point of the second sustain signal to a supply start time point of the third sustain signal.

20. The method of claim 18, wherein a duration of a third period ranging from a supply end time point of the first sustain signal to a supply start time point of the second sustain signal is more than a duration of a second period ranging from a supply end time point of the second sustain signal to a supply start time point of the third sustain signal, and
a duration of the first period is more than the duration of the second period.
